(19) United States
(12) Patent Application Publication
(10) Pub. No.: US 2007/0280388 A1
(43) Pub. Date: Dec. 6, 2007

(54) APPARATUS FOR AND METHOD OF CANCELLER TAP SHUTDOWN IN A COMMUNICATION SYSTEM

(75) Inventors: Rafi Dalla Torre, Givataim (IL); Itay Lusky, Hod Hasharon (IL); Nohik Semel, Kfar Saba (IL); Oran Keren, Ra'anana (IL); Ariel Yagil, Ramat Hasharon (IL)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/421,412

(22) Filed: May 31, 2006

(51) Int. Cl. H04B 3/20; H04B 1/10

(52) U.S. Cl. 375/350; 370/289; 370/291

(57) ABSTRACT

A novel and useful mechanism for shutting down very small canceller taps that have little influence on the output of the canceller. Disabling or completely disabling these taps results in a significant reduction in power consumption of the circuit incorporating the canceller. Shutting down very low valued canceller taps also results in reduced least mean square (LMS) noise caused by the jittering of the smaller taps of the canceller. Several methods are provided that determine the number and location of the taps to be shutdown. The mechanism of the invention is operative to shut down canceller taps that are lower than a predetermined threshold. Methods include comparing each individual tap to a threshold, comparing an average of each tap to a threshold, comparing groups of taps to a threshold and comparing an average of groups of taps to a threshold. Taps or groups of taps are smaller than the threshold are shutdown thus reducing the power consumption of the canceller.

### FIELD OF THE INVENTION

The present invention relates to the field of data communications and more particularly relates to an apparatus for and method of shutting down canceller taps in a communication system.

### BACKGROUND OF THE INVENTION

Modem network communication systems are generally of either the wired or wireless type. Wireless networks enable communications between two or more nodes using any number of different techniques. Wireless networks rely on different technologies to transport information from one place to another. Several examples, include, for example, networks based on radio frequency (RF), infrared, optical, etc. Wired networks may be constructed using any of several existing technologies, including metallic twisted pair, coaxial, optical fiber, etc.

Communications in a wired network typically occurs between two communication transceivers over a length of cable making up the communications channel. Each communications transceiver comprises a transmitter and receiver components. The receiver component typically comprises one or more cancellers. Several examples of the type of cancellers typically implemented in Ethernet transceivers, especially gigabit Ethernet transceivers include, echo cancellers, near-end crosstalk (NEXT) cancellers, far-end crosstalk cancellers (FEXT), etc.

The deployment of faster and faster networks is increasing at an ever quickening pace. Currently, the world is experiencing a vast deployment of Gigabit Ethernet (GE) devices. As the number of installed gigabit Ethernet nodes increases, the application of gigabit Ethernet devices to low power applications has become more and more common. The number and wide variety of low power applications results in the need for low power Ethernet transceivers.

The ability to shut down one or more canceller taps is particularly useful in low power applications where any reductions in power consumption are desirable. Further, it is desirable to have the canceller tap shutdown capabilities built into the communications transceiver without requiring significant modification to existing transceivers.

Thus, there is a need for a mechanism for disabling or shutting down one or more canceller taps thereby significantly reducing the power consumption of the integrated circuit without requiring extensive modifications to the transceiver.

### SUMMARY OF THE INVENTION

The present invention is a novel and useful mechanism for disabling or completely shutting down small valued canceller taps that have little influence on the interference output, e.g., mean squared error (MSE), of the interference canceller. Disabling or completely disabling these taps results in a significant reduction in power consumption of the circuit incorporating the canceller. Shutting down very low valued canceller taps also results in reduced least mean square (LMS) noise otherwise caused by the jittering of the smaller values taps of the interference canceller.

Several methods are provided that determine the number and location of the taps to be shutdown. The mechanism of the invention is operative to shut down canceller taps that are lower than a predetermined threshold. Methods include comparing each individual tap to a threshold, comparing an average of each tap to a threshold, comparing groups of taps to a threshold and comparing an average of groups of taps to a threshold. Taps or groups of taps are smaller than the threshold are shutdown thus reducing the power consumption of the canceller.

Thus, the mechanism of the present invention is operative to shutdown canceller tap coefficients that do not or substantially do not contribute to a reduction in echo. In other words, canceller taps that do not have to handle any significant reflections in the time domain are shut down. The mechanism of the invention is thus operative to shut down canceller taps that converge to a value of zero or approximately zero. The invention provides five methods of shutting down canceller taps as described herein below.

Although the mechanism of the present invention can be used in numerous types of communication networks, to aid in illustrating the principles of the present invention, the canceller tap shutdown mechanism is described in the context of an echo canceller incorporated in an Ethernet transceiver. It is appreciated that the invention is not limited to the example applications presented but can be applied to other communication systems as well without departing from the scope of the invention.

Note that some aspects of the invention described herein may be constructed as software objects that are executed in embedded devices as firmware, software objects that are executed as part of a software application on either an embedded or non-embedded computer system such as a digital signal processor (DSP), microcomputer, minicomputer, microprocessor, etc. running a real-time operating system such as WinCE, Symbian, OSE, Embedded LINUX, etc. or non-real time operating system such as Windows, UNIX, LINUX, etc., or as soft core realized HDL circuits embodied in an Application Specific Integrated Circuit (ASIC) or Field Programmable Gate Array (FPGA), or as functionally equivalent discrete hardware components.

There is therefore provided in accordance with the invention, a method of reducing the number of taps in a interference canceller having a plurality of taps, the method comprising the steps of comparing the plurality of taps of the interference canceller to a threshold and shutting down one or more taps of the interference canceller in response to the results of the step of comparing.

There is also provided in accordance with the invention, a interference canceller having a plurality of taps comprising tap shutdown means comprising compare means for comparing the plurality of coefficients to a threshold, shut down means for shutting down one or more taps based on the results of the comparison and filter means for canceling interference from a signal input to the interference canceller utilizing remaining active taps.

There is further provided in accordance with the invention, a method of reducing the power consumption of a interference canceller having a plurality of taps, the method comprising the steps of determining the contribution of each of the interference canceller taps to a reduction in interference of the interference canceller and disabling those taps whose contribution to the reduction in noise does not exceed a predetermined threshold.

There is also provided in accordance with the invention, a communications transceiver comprising a transmitter coupled to the communications channel, a receiver coupled to the communications channel, a interference canceller having a plurality of taps comprising tap shutdown means comprising compare means for comparing the plurality of coefficients to a threshold, shut down means for shutting down one or more taps based on the results of the comparison and filter means for canceling interference from a signal input to the interference canceller utilizing remaining active taps.

### BRIEF DESCRIPTION OF THE DRAWINGS

The invention is herein described, by way of example only, with reference to the accompanying drawings, wherein:

FIG. 1A is a block diagram illustrating the typical 1000Base-T noise environment;

FIG. 1B is a diagram illustrating the alien NEXT (ANEXT) noise environment;

FIG. 2 is a block diagram illustrating an example a 4-connector Ethernet cabling topology;

FIG. 3 is a graph illustrating the echo coefficients of the topology of FIG. 3;

FIG. 4 is a block diagram illustrating an example communications transceiver incorporating the canceller tap shutdown scheme of the present invention;

FIG. 5 is a block diagram illustrating an example canceller with tap shutdown constructed in accordance with the present invention;

FIGS. 6A, 6B and 6C are graphs illustrating the echo tap shutdown versus change in performance for Method #1;

FIGS. 7A, 7B and 7C are graphs illustrating the echo tap shutdown versus change in performance for Method #2; and

FIGS. 8A, 8B and 8C are graphs illustrating the echo tap shutdown versus change in performance for Method #4.

### DETAILED DESCRIPTION OF THE INVENTION

### Notation Used Throughout

The following notation is used throughout this document.

| Term | Definition |
|---|---|
| AGC | Automatic Gain Control |
| ANEXT | Alien Near-End Crosstalk |
| ASIC | Application Specific Integrated Circuit |
| AWGN | Additive White Gaussian Noise |
| DSP | Digital Signal Processor |
| EIA | Electrical Industry Association |
| ELFEXT | Equal Level Far-End Crosstalk |
| FBE | Feedback Equalizer |
| FEXT | Far-End Crosstalk |
| FFE | Feed forward Equalizer |
| FIR | Finite Impulse Response |
| FPGA | Field Programmable Gate Array |
| GE | Gigabit Ethernet |
| HDL | Hardware Description Language |
| IC | Integrated Circuit |
| IEEE | Institute of Electrical and Electronics Engineers |
| IIR | Infinite Impulse Response |
| ISI | Intersymbol Interference |
| LMS | Least Mean Square |
| LPF | Low Pass Filter |
| MDELFEXT | Multiple Disturber Equal Level Far-End Crosstalk |
| MSE | Mean Squared Error |
| NEXT | Near-End Crosstalk |
| PSELFEXT | Power Sum Equal Level Far-End Crosstalk |
| PSNEXT | Power Sum Near-End Crosstalk |
| RF | Radio Frequency |
| STP | Shielded Twisted Pair |
| TIA | Telecommunications Industry Association |
| UTP | Unshielded Twisted Pair |

### Detailed Description of the Invention

The present invention provides a novel mechanism for identifying and characterizing noise sources affecting a communications link, e.g., Gigabit Ethernet, using time and frequency domain analysis techniques. Detected noise sources are characterized and compared to an acceptable envelope mask. If the noise source is out of the permitted envelope mask as defined by the relevant standard, it is reported. The mechanism utilizes both time and frequency domain analysis to detect and characterize noise sources.

To aid in understanding the principles of the present invention, the description of the Ethernet noise characterization mechanism is provided in the context of an Ethernet transceiver circuit that can be realized in an integrated circuit (IC). The noise source characterization mechanism of the present invention has been incorporated in an Ethernet IC adapted to provide 10Base-T, 100Base-T and 1000Base-T communications over a metallic twisted pair channel. Although the invention is described in the context of a gigabit Ethernet PHY communications link, it is appreciated that one skilled in the art can apply the principles of the invention to other communication systems without departing from the scope of the invention. In addition, the noise characterization can be performed utilizing a conventional communications receiver without the need for special measurement equipment. This is achieved by reusing a portion of the functionality present on a typical receiver.

It is appreciated by one skilled in the art that the noise source characterization mechanism of the present invention can be adapted for use with numerous other types of wired communications networks such as coaxial channels, etc. without departing from the scope of the invention.

Note that throughout this document, the term communications device is defined as any apparatus or mechanism adapted to transmit, receive or transmit and receive data through a medium. The term communications transceiver is defined as any apparatus or mechanism adapted to transmit and receive data through a medium. The communications device or communications transceiver may be adapted to communicate over any suitable medium, including wired media such as twisted pair cable or coaxial cable. The term Ethernet network is defined as a network compatible with any of the IEEE 802.3 Ethernet standards, including but not limited to 10Base-T, 100Base-T or 1000Base-T over shielded or unshielded twisted pair wiring. The terms communications channel, link and cable are used interchangeably.

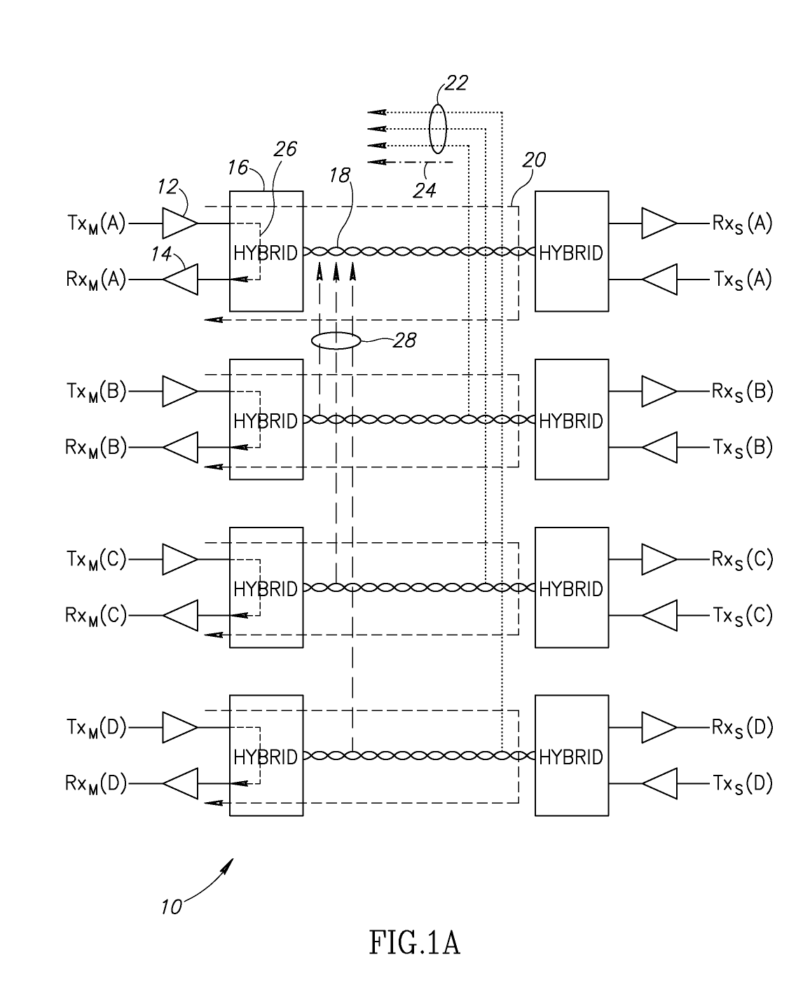

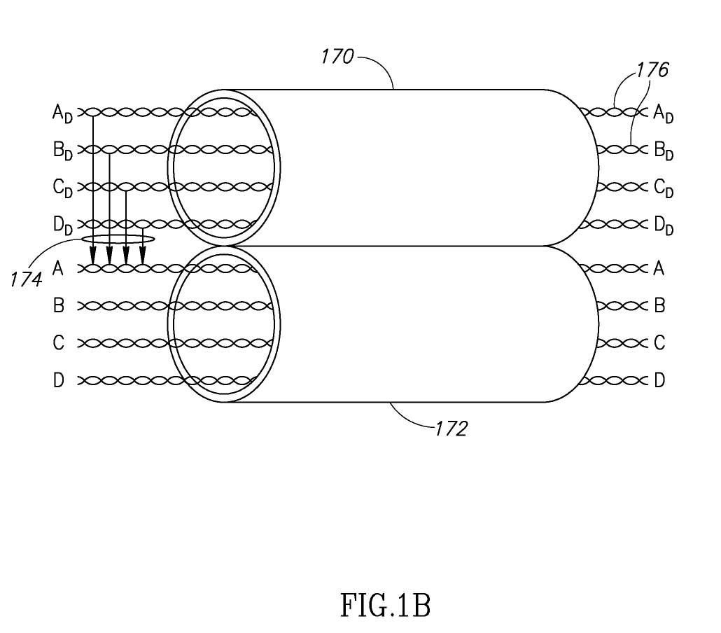

The Ethernet PHY operating environment is typically exposed to diverse interference sources. A block diagram illustrating the typical 1000Base-T noise environment is shown in FIG. 1A. The environment, generally referenced 10, comprises two transceivers Master (M) and Slave (S), each comprising a plurality of transmitters 12, receivers 14 and hybrid circuits 16. The transceivers are coupled by a plurality of twisted pair cables 18. A gigabit Ethernet communications link is characterized by full duplex transmission over Category 5 and higher cable that may be shielded (STP) or unshielded twisted pair (UTP) cable. The cable comprises four twisted metallic copper pairs wherein all four pairs are used for both transmission and reception. Note that for notation purposes, each one of the twisted pairs is referred to as a ‘channel’ and the combined four twisted pair bundle generating one gigabit Ethernet connection is referred to as a ‘cable’.

In operation, each transceiver receives an input data stream from an external data source such as a host or other entity (not shown). The transceiver generates an output symbol stream from the input data stream and transmits the output symbol stream over the communications channel to the transceiver on the other side. The transceivers on either end of a channel are considered link partners. One is designated a master, the other a slave. A link partner can be either active or inactive. An inactive link partner is a transceiver that is not transmitting at the moment. An active link partner is a transceiver that is currently transmitting.

In the receive direction, each transceiver receives a receive signal from the communications channel. The receive signal may comprise an input symbol stream transmitted from the link partner. The transceiver generates an output from this input symbol stream. The receive signal may also comprise a signal representing energy from any number of interference sources, e.g., an echo signal representing the original transmitted signal that has been reflected back towards the transceiver. The transmitted signal may be reflected back due to a channel fault such as an open cable, shorted cable, unmatched load or any irregularities in impedance along the length of the cable. Such irregularities may be caused by broken, bad or loose connectors, damaged cables or other faults.

The Ethernet PHY environment is typically exposed to diverse interference sources.

Several of these interference sources are illustrated in FIG. 1A, and include: near-end echo 26, far-end echo 20, attenuation 24, near-end crosstalk 28 and far-end crosstalk 22. The main interference sources (i.e. Ethernet impairments or noise sources) an Ethernet transceiver is exposed to are described below. Note that these and other impairments may be applicable to other communication link PHY schemes and are not to be limited to gigabit Ethernet. The requirements of the impairments to be monitored are defined by the IEEE 802.3 1000Base-T specification. The requirements presented infra apply to a 100 meter cable at all frequencies from 1 MHz to 100 MHz.

Insertion loss/Attenuation: Insertion loss (denoted by line 24 in FIG. 1A) is the intersymbol interference (ISI) introduced to the far side transmitted signal and is compensated by the equalizer in the receiver. The worst case insertion loss is defined by the IEEE 802.3 standard as:

Insertion_Loss(f)<2.1 ^{0.529}+0.4/f dB (1)

where f denotes frequency. Insertion loss and ISI interference are usually mitigated using an adaptive equalizer. The equalizer may comprise a feed forward equalizer (FFE) or feedback equalizer (FBE).

Return loss (echo)/near-end echo rejection: The echo signal (denoted by line 26 in FIG. 1A) is the reflection of the transmitted signal onto the receiver path. The echo can be a near-end echo reflection due to the full duplex usage of each pair or a far-end reflection due to unmatched hardware connection components along the cable topology or at the far-side connector. The worst case far-end return loss is defined by the IEEE 802.3 standard as:

$$Return\_Loss ( f ) \{ \begin{matrix}15 & ( 1 - 20 MHz ) \\ 15 - 10 {log}_{10} ( f / 20 ) & ( 20 - 100 MHz )\end{matrix} \} dB \qquad ( 2 )$$

where f denotes frequency and where the requirements for CAT5E is modified from 15 dB to 17 dB (i.e. an increase of 2 dB). Note that a high level of near-end echo signal may indicate a printed circuit board fault. Note also that the near-end echo reflection level is implementation specific and may be compensated for by the hybrid analog block 16 (FIG. 1A). An adaptive echo canceller is a well-known technique for canceling echo signals. The adaptive echo canceller uses the least mean square (LMS) method or its equivalent.

Near-end crosstalk (NEXT) and far-end crosstalk (FEXT): NEXT crosstalk (denoted by lines 28 in FIG. 1A) and FEXT crosstalk (denoted by line 22 in FIG. 1A) are undesired signals coupled between adjacent pairs. The NEXT is noise coupled from near-side adjacent transmitters (i.e. of the other three pairs). FEXT is noise coupled from far-side adjacent transmitters. An adaptive NEXT canceller utilizing the LMS or equivalent algorithm is typically used to cancel NEXT signals. Similarly, an adaptive FEXT canceller utilizing the LMS or equivalent algorithm is typically used to cancel FEXT signals.

The worst case NEXT coupling is defined by the IEEE 802.3 standard as:

NEXT(f)>27.1−16.8 log₁₀(f/100) dB (3)

where f denotes frequency. Note that the standard also defines the following properties:
1. Equal Level FEXT (ELFEXT) is defined as the noise coupled from far-side transmitters to a far-side link partner and can be formulated as

ELFEXT=FEXT−Insertion_loss (4)
2. Multiple Disturber ELFEXT (MDELFEXT) is defined as the different ELFEXT coupled from each of the three adjacent link partners in accordance with the following masks:

$$MDELFEXT ( f ) = \{ \begin{matrix}17 - 20 {log}_{10} ( f / 100 ) \\ 19.5 - 20 {log}_{10} ( f / 100 ) dB \\ 23 - 20 {log}_{10} ( f / 100 )\end{matrix} \qquad ( 5 )$$

where f denotes frequency and where the sum of the three ELFEXT signals is defined as Power Sum ELFEXT (PSELFEXT) which is limited by:

PSELFEXT(f)>14.4−20 log₁₀(f/100) dB (6)

Alien NEXT (ANEXT): A diagram illustrating the alien NEXT (ANEXT) noise environment is shown in FIG. 1B. The ANEXT noise (denoted by lines 174) is coupled to the modem receive path associated with the twisted pairs 176 in cable 172 from adjacent twisted pair links in cable 170. Unlike the NEXT noise signals, which are generated from a known transmitted sequence and therefore can be cancelled, the ANEXT noise signal is unknown and is thus much harder to cancel. The IEEE 802.3 standard defines the ANEXT as a 25 mV peak-to-peak signal generated by an attenuated l100Base-TX signal coupled to one of the receiver pairs.

Note that this model for the ANEXT may not be accurate since the ANEXT cannot be separated from the external coupled noise definition. It is assumed, however, that the external noise is composed of AWGN and the colored Alien NEXT. The standard does specify the PSNEXT loss as follows:

PSNEXT_loss(f)<35−15 log₁₀(f/100) dB (7)

where f denotes frequency.

External noise: External noise is defined by the IEEE 802.3 standard as noise coupled from external sources and is bounded at 40 mV peak-to-peak (with 3 dB LPF at 100 MHz).

The echo, NEXT and sometimes the FEXT impairments are mitigated using dedicated cancellers. These cancellers typically consume significant hardware resources and a substantial amount of digital transceiver die area. In a typical gigabit Ethernet transceiver, for example, the integrated circuit (IC) area dedicated to the canceller may consume over 50% of the total digital portion of the IC. Thus, it is advantageous to reduce the power consumption of one or more cancellers used in the receiver.

### Ethernet Cable and Topology

Cabling used for Ethernet applications is specified in two different standards. One of the standards is the Telecommunications Industry Association (TIA)/Electrical Industry Association (EIA)-568-B and the other is the ISI_IEC_{—}11801_{—}2002. In accordance with these standards, Ethernet cabling has several limitations regarding permitted topologies and configurations. For example, the standards specify that the maximum number of allowed connectors (and hence the maximum number of allowed reflection points) between two links is limited to four.

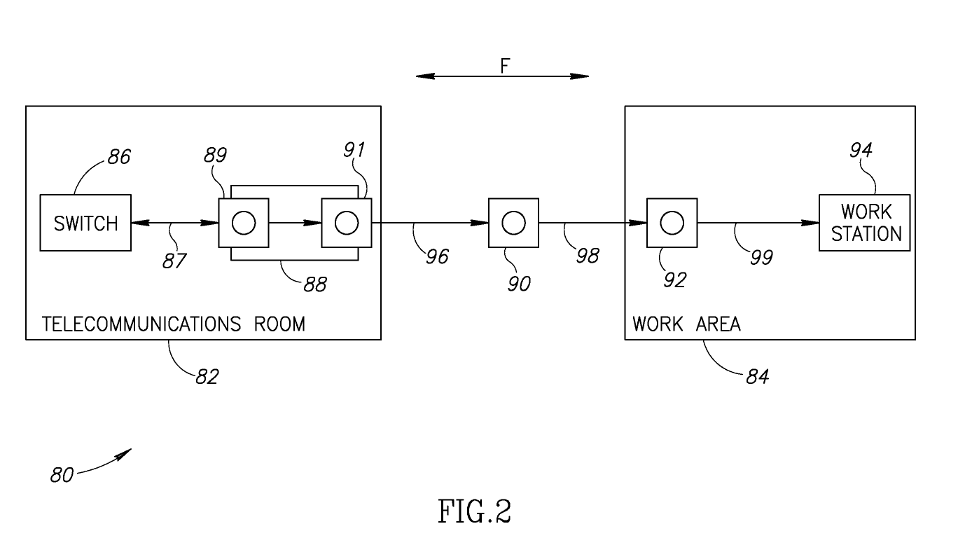

A block diagram illustrating an example a 4-connector Ethernet cabling topology is shown in FIG. 2. The example topology, generally referenced 80, comprises a telecommunications room 82 on one end and a work area 84 on the other end coupled via two cable segments 96, 98. The topology 80 is an example of an allowed Ethernet cabling system topology where the maximum number of connectors is used, namely the patch cable 83 connectors 89, 91 coupled to the switch 86 via the equipment cable 87, consolidation point 90 and connector 92 at MUTOA of the work area cable 99 coupled to the work station 94.

To aid in illustrating the principles of the present invention, the canceller tap shutdown mechanism is described in the context of an echo canceller incorporated in an Ethernet transceiver. Note that it is not intended that the invention be limited to echo cancellers. It is appreciated by one skilled in the art that the invention can be applied to numerous other types of cancellers, such as NEXT, FEXT, etc., without departing from the spirit and scope of the present invention.

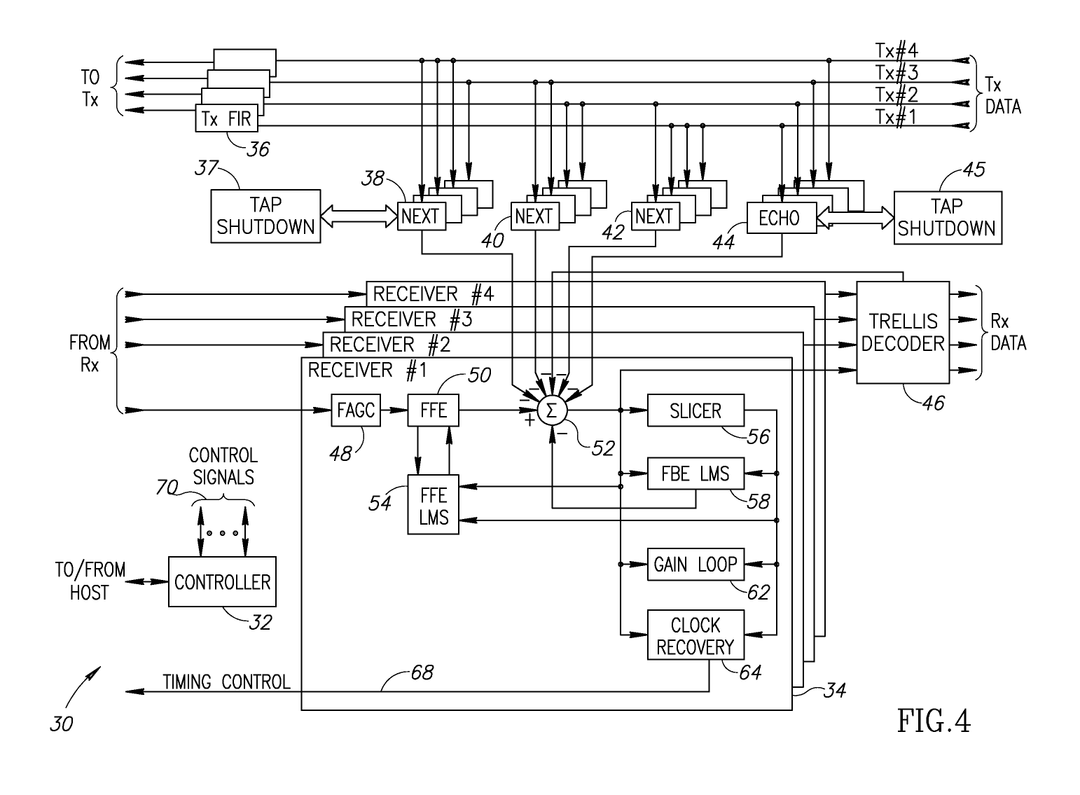

A block diagram illustrating an example communications transceiver incorporating the canceller tap shutdown scheme of the present invention is shown in FIG. 4. The gigabit Ethernet transceiver, generally referenced 30, comprises TX FIR filter blocks 36 (one for each of four twisted pairs), four receiver blocks 34, controller 32, NEXT blocks 38, 40, 42, echo canceller 44, tap shutdown blocks 37, 45 and Trellis decoder 46. Each of the receiver blocks 34 comprises fine automatic gain control (AGC) 48, feed forward equalizer (FFE) 50, least mean squares (LMS) block 54, adder 52, slicer 56, feedback equalizer (FBE) LMS 58, gain loop 62 and clock recovery block 64.

In operation, receivers #1, #2, #3 and #4 receive the appropriate NEXT and echo canceller signals from the NEXT blocks 38, 40, 42 and echo canceller blocks 44, respectively. For each receiver, corresponding to a twisted pair, the NEXT is calculated from the TX signals for the other three pairs. For example, the NEXT for receiver #1 (i.e. pair #1), is calculated from signals TX #2, TX #3 and TX #4.

The clock recovery block generates the timing control signal 68. Controller 32 communicates with a host (not shown) and provides administration, configuration and control to the transceiver via plurality of control signals 70.

The tap shutdown blocks 37, 45 in combination with the canceller blocks, implement the canceller tap shutdown mechanism of the present invention and are adapted to shutdown one or more canceller taps depending on particular criteria as described in more detail infra. In this example transceiver 30, the tap shutdown mechanism is applied to each of the NEXT cancellers 38, 40, 42 for each twisted pairs and to the echo canceller 44. It is appreciated that the invention can be applied to other types of cancellers as well and is not intended to be limited to NEXT and echo cancellers only.

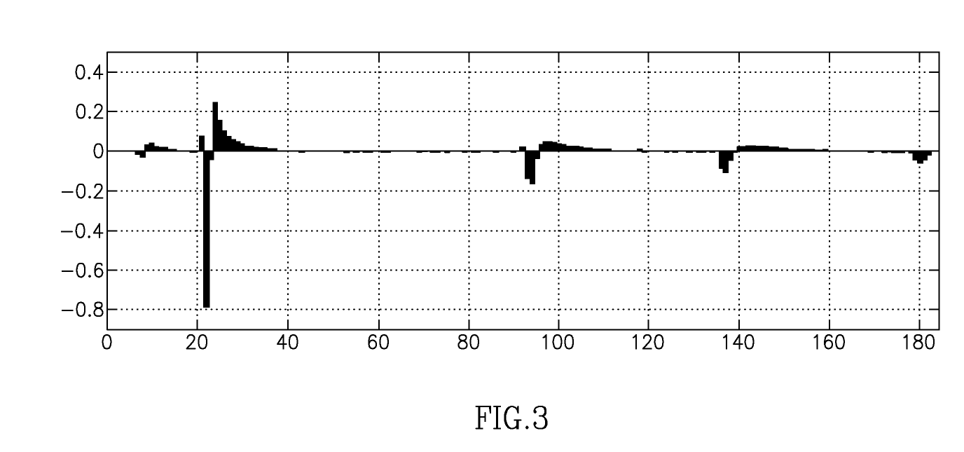

A graph illustrating the echo coefficients of the topology of FIG. 2 is shown in FIG. 3. The echo canceller functions to cancel the echo reflected back towards the receiver. It converges to be equivalent to the path from the transmitter output to the slicer. Typically this path consists of several reflections resulting in large echo taps at these reflections with ‘dead zones’ of small echo taps between the reflections. These dead zones are characterized by very small echo taps that jitter around zero.

The graph of FIG. 3 is generated by examining the impulse response of the channel. This is measured by transmitting a pulse on the channel at t=0 and measuring the response. Each received sample is effectively the transmitted symbol convolved with the discrete impulse response.

In accordance with the present invention, the goal of the canceller tap shutdown mechanism is to disable or completely shutdown very small echo taps that have little influence on the echo mean squared error (MSE) and hence little influence on the total MSE. By disabling or completely disabling these taps, the power consumption of the transceiver circuit can be significantly reduced. A further advantage of the shutting down very low valued canceller taps is that the least mean square (LMS) noise caused by the jittering of the smaller taps of the echo canceller is also significantly reduced.

With reference to FIG. 3, since the number of connecting hardware points (i.e. connectors) is limited, it can be assumed that the number of reflection point is limited as well. Although the exact location of these points cannot be known in advance, it can be assumed with high probability that not all echo canceller taps are necessary in performing the actual echo mitigation. Furthermore, activating an echo canceller tap at a location that does not have a reflection actually degrades performance without any offsetting benefit. The performance degradation is caused, as explained supra, by the increase in LMS noise which is the result of the jittering around zero of the small canceller taps.

Thus, the mechanism of the present invention is operative to shutdown canceller tap coefficients that do not or substantially do not contribute to a reduction in echo. In other words, canceller taps that do not have to handle any significant reflections in the time domain are shut down. The mechanism of the invention is thus operative to shut down canceller taps that converge to a value of zero or approximately zero. The invention provides five methods of shutting down canceller taps as described herein below.

### Canceller Tap Shutdown Method #1

In this method, a tap is shut down if its absolute value is less than a threshold as expressed below.

if{|echo_canceller[n]|<TH [symbol] echo_canceller[n]=0 (8)

The advantage of this method is that it is a relatively ‘inexpensive’ method. A disadvantage is that it suffers from sensitivity to tap jitter around the threshold value during adaptation. With this method, there is a potential risk that a tap will be shutdown that provides some contribution to interference cancellation but due to adaptation noise became close to zero value. The output of this method comprises a bit for each tap in the canceller indicating whether it is active or shutdown.

### Canceller Tap Shutdown Method #2

In this preferred method, a tap is shut down if its mean absolute value is less than a threshold as expressed below.

if{mean(|echo_canceller[n]|)<TH [symbol] echo_canceller[n]=0 (9)

The advantage of this method is that it does not suffer from the sensitivity problem associated with Method #1 supra since adaptation jitter is smoothed as a result of the averaging. The output of this method comprises a bit for each tap in the canceller indicating whether it is active or shutdown. This method utilizes a sliding window of a plurality of clock cycles (e.g., 1000 clock cycles) in which each tap is averages over the window size.

One possible way to calculate the mean is to preserve the historical values of all the taps for the duration of the window. A second and preferred way is to utilize an infinite impulse response (IIR) filter to avoid the requirement of storing the historical values of each tap for the duration of the window,

### Canceller Tap Shutdown Method #3

In this method, taps are shut down only if the sum of the absolute value of a certain number ‘X’ of sequential taps is less than X times a threshold as expressed below.

$$if \{ {\sum }_{X} \vert echo\_canceller [ n ] \vert < X \cdot TH \} ⇒ echo\_canceller [ n … n + X ] = 0 \qquad ( 10 )$$

This method is operative to shutdown X taps at a time. A number of X sequential taps are shutdown only if a sequence of X taps can be found that do not contribute to interference cancellation. The advantage of this method is that it provides a higher confidence level when taps are shut down. Disabling an entire sequence of taps saves a large amount of power. In addition, the method is less sensitive to the jitter effect. A disadvantage, however, is that it reduces the total number of taps that can be shut down since the probability of finding X sequential taps that can be shut down is lower. The number of taps in a group can be set in accordance with the particular application, e.g., 5 to 10 taps per group. This method also is operative to avoid shutting down taps that are near large valued groups of taps since they will likely be summed with the larger adjacent taps. This method is more robust to the tap jitter effect (also known as timing jitter). This is due to the fact that the jitter effect causes the reflection ‘seen’ and cancelled by each tap to constantly shift. Therefore, a tap that does not contribute to the actual filtering at one point in time may be essential at a later point in time. Thus, shutting down only sequential taps that are close to zero reduces the effect of the jitter.

### Canceller Tap Shutdown Method #4

In this method, ‘X’ sequential taps are shut down only if the sum of the absolute value of the averaged taps value is below a predefined threshold as expressed below.

$$if \{ {\sum }_{X} mean ( \vert echo\_canceller [ n ] \vert ) < X \cdot TH \} ⇒ echo\_canceller [ n … n + X ] = 0 \qquad ( 11 )$$

This method is similar to Method #2 described supra combined with the sequential tap feature of Method #3. Similar to Method #3, it is operative to shutdown X taps at a time. The method averages the values of the taps within a group. A group may comprise any number of taps, e.g., 5 to 10, depending on the particular application. This method is the least sensitive to jitter compared to the other four methods.

### Canceller Tap Shutdown Method #5

This method encompasses Methods #1 through #4 described supra with the difference being that the actual filtered output of the canceller is used rather than the canceller filter tap values. Depending on the particular implementation, it may be easier to monitor the filtered output energy rather than the actual tap values. Thus, all four methods described above are applicable to examining the filtered output. In this method, the filtered output is compared to the same thresholds used in Methods #1 through #4 after they are normalized using the canceller input signal energy.

Regardless of the method used to determine the tap to shutdown, the shutdown method can be performed either once during startup, periodically or continuously during the actual active link. Thus, depending on the implementation, a determination of which taps to shutdown and which to activate can be made (1) periodically; (2) continuously; (3) at any time or (4) can be performed in accordance with dynamic changes in the channel.

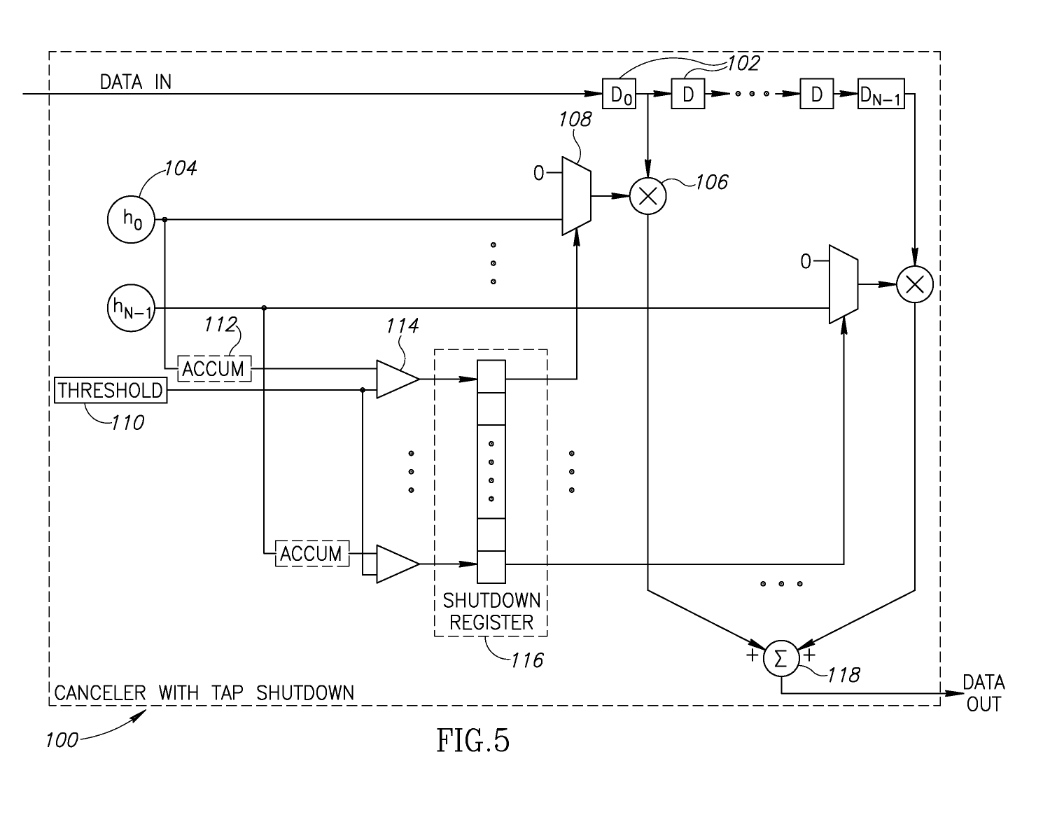

An example canceller with tap shutdown mechanism of the present invention will now be described. A block diagram illustrating an example canceller with tap shutdown constructed in accordance with the present invention is shown in FIG. 5. The canceller, generally referenced 100, comprises an FIR type filter architecture with circuitry adapted to shut down one or more taps in response to a threshold input.

The canceller 100 comprises a plurality of N registers 102 (e.g., D-flip flops D₀ to D_{N-1}) for storing input data coupled to multipliers 106. The output of each register is coupled to a multiplier whose second input is the output of a 2 to 1 multiplexer 108. The input of each multiplexer comprises a canceller tap coefficient 104 and zero. Each tap coefficient is compared with the threshold stored in a register 110 via comparator 114. The results of the comparisons are stored in the shutdown register 116. Depending on the value of the shutdown bit, either the tap coefficient or a zero value is multiplied with the input data. A value of zero effectively shuts down a tap as a multiplication is not necessary. The outputs of the multipliers are summed via adder 118, the output of which is the filtered output of the canceller. Thus, depending on the threshold value, only a portion of the coefficients h₀ through h_{N-1} are used by the canceller. This example canceller implements Method #1 described above where each tap is compared to a threshold.

The canceller 100 also implements preferred Method #2 with the incorporation of the optional accumulators 112 placed before each comparator. The accumulators function to calculate a moving average of each individual canceller tap value. This greatly reduces the effects of tap jitter caused by the value of a tap jittering around the value of the threshold from clock cycle to clock cycle.

The thresholds used in the comparisons can be determined empirically by simulation or by trial and error. If simulation is used, the thresholds determined are not dynamic, i.e. they are calculated a priori. Preferably, several channel model are used including the use of actual cables in real topologies. For each cable topology, simulations are performed to determine the threshold. For each possible threshold, the number of taps shutdown is observed including the tradeoffs associated with that number. For each topology an optimum threshold can be found. In general, the more taps that are shutdown, the greater the reduction in power consumption. The tradeoff, however, is increased noise levels.

Several graphs illustrating the performance of the canceller tap shutdown mechanism for different numbers of taps shutdown and different thresholds will now be presented. In each graph, the starred data points represent the number of taps omitted as indicated by a shutdown counter (right axis) as the threshold is increased (x-axis). The circled data points represent the echo MSE in units of dB (left axis). Sets of graphs are provided for Methods #1, #2 and #4. Each set comprises three graphs, each corresponding to three different channels A, B, C.

The graphs are used to optimize the parameters for each topology. Each graph defines a threshold level that has trade offs associated with it. On the one hand, power consumption is reduced by closing more taps when a higher threshold is used but with an increase in echo noise since the channel is modeled less and less accurately as the number of taps in reduced.

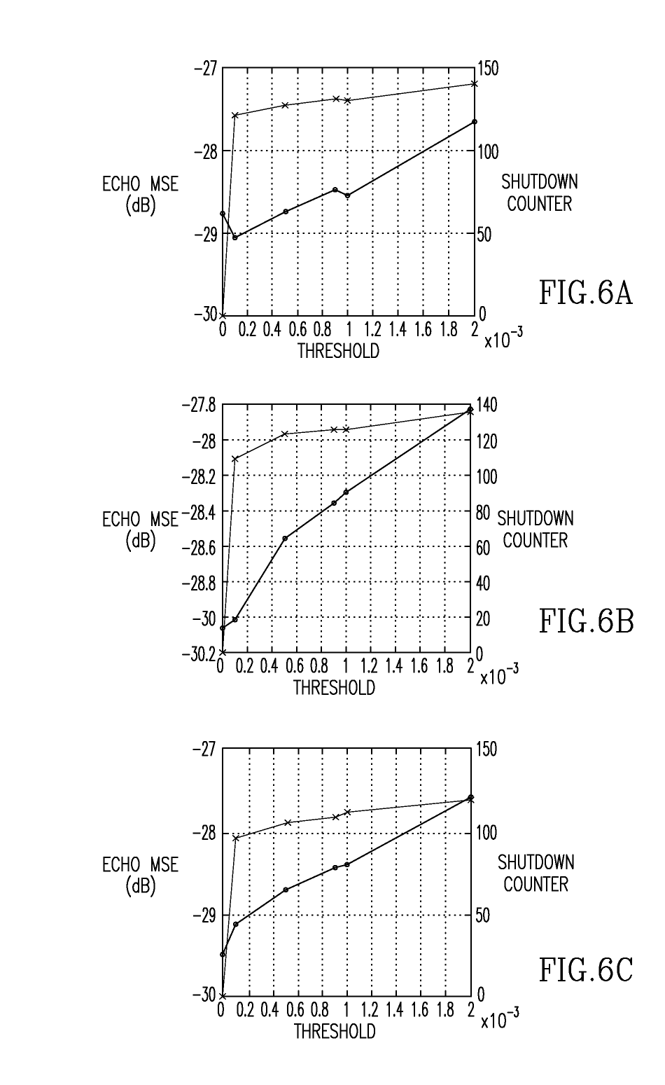

Graphs illustrating the echo tap shutdown versus change in performance for Method #1 are shown in FIGS. 6A, 6B and 6C. This method provides moderate controllability for the performance versus power consumption tradeoff since the number of taps that are shutdown changes dramatically with only a minor change in threshold. An advantage of this method, however, is the lower hardware implementation cost. The large jump in the number of taps shutdown is due to the jitter of many of the taps around zero. Once a tap jitters around zero they are shut down.

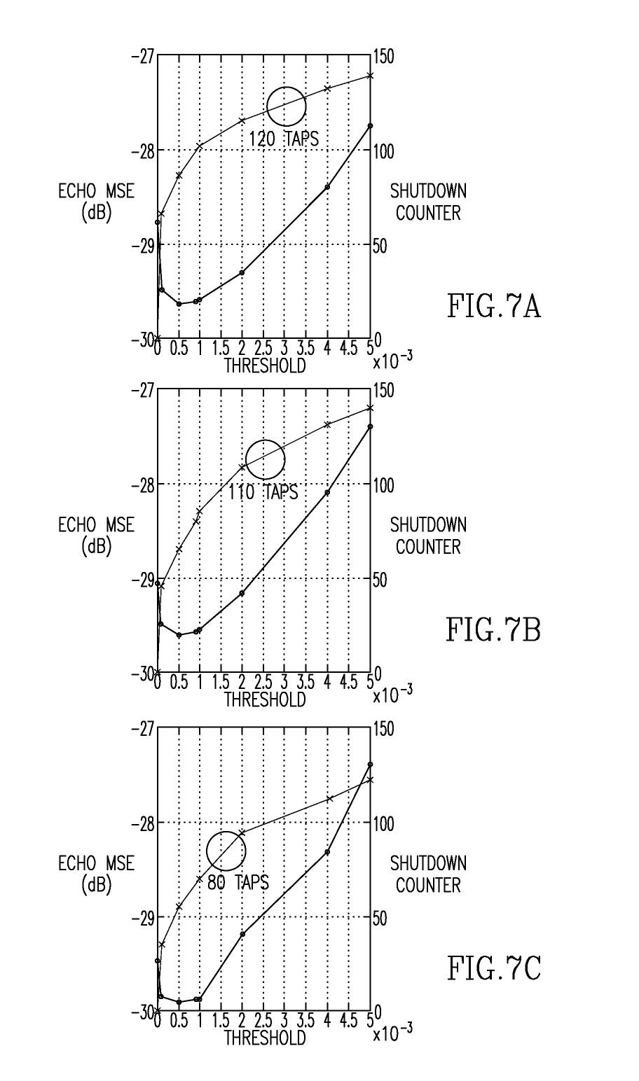

Graphs illustrating the echo tap shutdown versus change in performance for Method #2 are shown in FIGS. 7A, 7B and 7C. It is clear that this method provides good controllability for the performance versus power consumption tradeoff since the number of taps that are shut down changes gradually as a function of the change in threshold. For some threshold levels the echo canceller filtering performance is improved as the number of taps shutdown increases. Usually when as more taps are closed it is expected that the noise increases because the channel is modeled in a less accurate manner. Here, however, the opposite occurs wherein additional taps shutdown results in better performance. One of the drawbacks of the LMS algorithm is that any jittering around tap values introduces noise into the system. In the case of a small tap that is not a real reflection, just noise, shutting it down to zero saves power but also removes any jittering noise (referred to as adaptation noise). This results in improved performance as the number of taps removed increases since the taps removed do not contribute to the echo cancellation but only add adaptation noise.

The level of the echo noise (as measured by the echo power) represents how much the echo influences the received signal. In each figure, the number of taps (as represented by the circle in each Figure) is taken as the number of taps corresponding to the same echo noise when all taps are active. The graphs show that as the number of taps shutdown increases, the MSE decreases to a certain level and then begins increasing as the number of taps shutdown increases. At some point, too many taps are shutdown and the echo noise becomes worse than with all taps on. It is not desirable to go beyond this point because performance begins to drop. Thus, better performance than with all taps active can be achieved or the same performance can be achieved using fewer taps.

As an example, considering FIG. 7B, 80 to 120 taps (from an initial number of approximately 180) can be shut down without any degradation in performance. Note, however, that this method may be more expensive in terms of hardware costs compared to Method #1 due to the need to incorporate a mechanism to average the tap values for each canceller filter tap. Some of the hardware requirements can be reduced by sharing a single averaging circuit for a group of taps using multiplexing or other techniques.

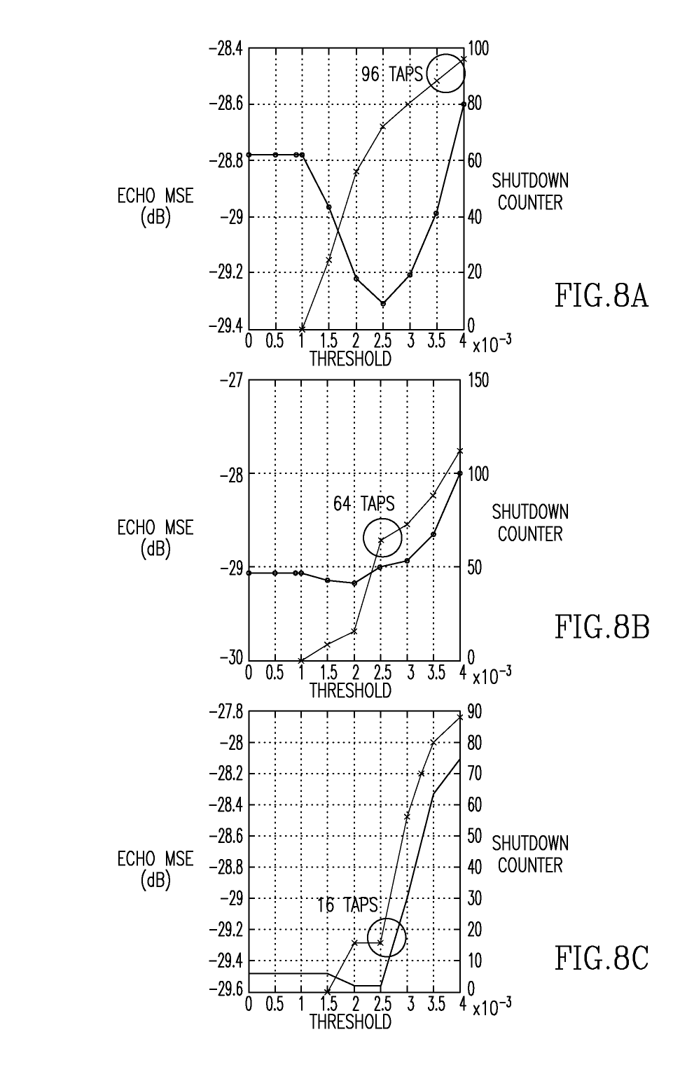

Graphs illustrating the echo tap shutdown versus change in performance for Method #4 are shown in FIGS. 8A, 8B and 8C. This example uses an eight tap sequence size, meaning that taps were shutdown only if eight sequential taps met the threshold criteria. As is seen from the results shown, the total number of taps that can be shutdown is decreased as explained supra since the probability of finding eight sequential taps that do not contribute to the actual canceller filtering is reduced. On the other hand, however, this method is more robust to the tap jitter effect. This is due to the fact that the jitter effect causes the reflection ‘seen’ and cancelled by each tap to constantly shift. Therefore, a tap that does not contribute to the actual filtering at one point in time may be essential at a later point in time. Thus, shutting down only sequential taps that are close to zero reduces the effect of the jitter.

Considering channel A in FIG. 8A, with this method, even with the same tap value a certain number of taps are shut down which is not influenced by increasing the threshold because no taps are closed. When taps start being shutdown, we see an improvement up to a point where disabling more taps reduces performance. For channel B, the optimization point is very small. For channel C it is even worse.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. A method of reducing the number of taps in a interference canceller having a plurality of taps, said method comprising the steps of:
comparing said plurality of taps of said interference canceller to a threshold; and
shutting down one or more taps of said interference canceller in response to the results of said step of comparing.

2. The method according to claim 1, wherein said canceller comprises an echo canceller.

3. The method according to claim 1, wherein said canceller comprises a near-end crosstalk (NEXT) canceller.

4. The method according to claim 1, wherein said step of comparing comprises the step of comparing each individual tap coefficient to a threshold.

5. The method according to claim 1, wherein said step of shutting down one or more taps comprises the step of shutting taps whose value is less than said threshold.

6. The method according to claim 1, wherein said step of comparing comprises the step of comparing a mean of each individual tap coefficient to a threshold.

7. The method according to claim 1, wherein said step of shutting down one or more taps comprises the step of shutting taps whose mean value is less than said threshold.

8. The method according to claim 1, wherein said step of comparing comprises the step of comparing a sequence of tap coefficients to said threshold.

9. The method according to claim 1, wherein said step of shutting down one or more taps comprises the step of shutting down a sequence of taps if the sum of said sequence of taps is smaller than said threshold.

10. The method according to claim 1, wherein said step of comparing comprises the step of comparing a sum of the mean values of a sequence of tap coefficients to said threshold.

11. The method according to claim 1, wherein said step of shutting down one or more taps comprises the step of shutting down a sequence of taps if a sum of the mean of said sequence of taps is smaller than said threshold.

12. The method according to claim 1, wherein said threshold is chosen such that it yields the same noise output with one or more taps shutdown as compared to the noise output corresponding to all taps being active.

13. A interference canceller having a plurality of taps, comprising:
tap shutdown means comprising:
compare means for comparing said plurality of coefficients to a threshold;
shut down means for shutting down one or more taps based on the results of said comparison; and
filter means for canceling interference from a signal input to said interference canceller utilizing remaining active taps.

14. The interference canceller according to claim 13, wherein said interference canceller comprises an echo canceller.

15. The interference canceller according to claim 13, wherein said interference canceller comprises a near-end crosstalk (NEXT) canceller.

16. The interference canceller according to claim 13, wherein said compare means comprises means for comparing each individual tap coefficient to a threshold.

17. The interference canceller according to claim 13, wherein said shut down means comprises means for shutting down one or more taps comprises the step of shutting taps whose value is less than said threshold.

18. The interference canceller according to claim 13, wherein said compare means comprises means for comparing a mean of each individual tap coefficient to a threshold.

19. The interference canceller according to claim 13, wherein said shut down means comprises means for shutting taps whose mean value is less than said threshold.

20. The interference canceller according to claim 13, wherein said compare means comprises means for comparing a sequence of tap coefficients to said threshold.

21. The interference canceller according to claim 13, wherein said shut down means comprises means for shutting down a sequence of taps if the sum of said sequence of taps is smaller than said threshold.

22. The interference canceller according to claim 13, wherein said compare means comprises means for comparing a sum of the mean values of a sequence of tap coefficients to said threshold.

23. The interference canceller according to claim 13, wherein said shut down means comprises means for shutting down a sequence of taps if a sum of the mean of said sequence of taps is smaller than said threshold.

24. The interference canceller according to claim 13, further comprising means for selecting said threshold such that it yields the same noise output with one or more taps shutdown as compared to the noise output corresponding to all taps being active.

25. A method of reducing the power consumption of a interference canceller having a plurality of taps, said method comprising the steps of:
determining the contribution of each of said interference canceller taps to a reduction in interference of said interference canceller; and
disabling those taps whose contribution to the reduction in noise does not exceed a predetermined threshold.

26. A communications transceiver, comprising:
a transmitter coupled to said communications channel;
a receiver coupled to said communications channel;
a interference canceller having a plurality of taps, comprising:
tap shutdown means comprising:
compare means for comparing said plurality of coefficients to a threshold;
shut down means for shutting down one or more taps based on the results of said comparison; and
filter means for canceling interference from a signal input to said interference canceller utilizing remaining active taps.

27. The transceiver according to claim 26, wherein said interference canceller comprises an echo canceller.

28. The transceiver according to claim 26, wherein said interference canceller comprises a near-end crosstalk (NEXT) canceller.

29. The transceiver according to claim 26, wherein said compare means comprises means for comparing a mean of each individual tap coefficient to a threshold.

30. The transceiver according to claim 26, wherein said shut down means comprises means for shutting taps whose mean value is less than said threshold.
